(19) United States
(12) Patent Application Publication
(10) Pub. No.: US 2015/0186842 A1
(43) Pub. Date: Jul. 2, 2015

(54) SYSTEM AND METHOD FOR VERIFYING THE DELIVERY OF A PARCEL

(71) Applicant: Dimitri Daniarov, Greenwich, CT (US)

(72) Inventor: Dimitri Daniarov, Greenwich, CT (US)

(21) Appl. No.: 14/143,220

(22) Filed: Dec. 30, 2013

(51) Int. Cl. G06Q 10/08

(52) U.S. Cl. CPC G06Q 10/0838

(57) ABSTRACT

Systems and methods are disclosed for determining with certainty the time and place that a shipped package or envelope (referred to herein as a “Parcel”) reaches its intended destination. In order to provide “proof of delivery” at the intended location, both a scan of the shipping document(s) and a digital image (snap shot) of the package left by the carrier is obtained. The photo image may, for example, be uploaded to a server. The photo image(s) and other package identification data (for example, air bill number, delivery vehicle identification number and/or other identification data, etc.) obtained from the scan, may then be correlated to provide the desired “proof of delivery”. The server can be used to determine the appropriate individual(s) to be contacted, and may generate a notification message that includes delivery information along with photographic evidence of the delivery, typically and email or an SMS message may be generated and sent to the interested parties (i.e., the shipper and the receiver). Among other things, the SCANnSNAP™, Photo Proof™ protocol will allow for review of where a package was actually left so as to be useful in retrieving lost packages (such as when a package is in fact delivered; but to the wrong address), finding packages based on the evidence of where it was actually left as provided by the photo.

### FIELD OF THE INVENTION

The present invention relates generally to systems and methods for handling the delivery of letters and packages (“parcels”). Specifically, systems and methods are defined for obtaining and transmitting information about a parcel and one or more digital images of a parcel upon its delivery. Interested parties may then be notified about the parcel and when and where the parcel was delivered.

### BACKGROUND OF THE INVENTION

Today the United States Post Office delivers over 700 million pieces of mail a day to homes and businesses. Private services such as Federal Express and United Parcel Services add to this total. Often, a significant percentage of those pieces never arrive to the intended recipients because they are lost, delivered to the wrong address or stolen. Prior art systems and methods have been employed to attempt to minimize such losses such as described in U.S. Pat. No. 7,640,169 issued to Horton. However, Horton uses complicated systems and methods in order to collect a multitude of parameters for locating and identifying the delivery of a good. On the other hand, the present invention allows for simple systems and methods that allow the person delivering the parcel to simply scan the package and snap one or more digital photographs of the location where the parcel was left. Such information may be sent directly to interested parties (i.e., the shipper and the recipient) in real time or maybe stored for later use to aid in the assistance in locating lost parcels.

There is a need for simple, high-speed systems and methods for quickly and easily facilitating proof of delivery of the great volume of parcels delivered daily; and notification to interested parties of the delivery of parcels. There is a further need to be able to quickly and easily locate parcels delivered to the wrong destination to enable the parcels to be recovered and properly be delivered.

### SUMMARY OF THE INVENTION

In an embodiment of the present invention, a method for providing proof of the disposition of a parcel that is being transported by a carrier may include receiving digital information about a parcel. The digital information may include information about the particular parcel, the shipper and the receiver's electronic mail address information and/or short message service information such as a mobile telephone number to send a text message, one or more digital photographs of the parcel, and one or more digital photographs of the parcel's location. This embodiment may also include communicating with a wire or wireless network to upload the parcel's digital information to a server. The embodiment may further include storing the parcel's digital information in a database operatively connected to the server and using one or more means, such as a processor or time indexed database, to time stamp the parcel's digital information. Still further, the embodiment may include using an electronic message address or short messaging service information from the parcel's digital information to generate a delivery notification message to the shipper and/or receiver. Lastly, an embodiment may also include transmitting the delivery notification to the shipper and receiver.

In another embodiment of the invention, a method for providing proof of the disposition of a parcel that is being transported by a carrier is provided and may include receiving digital information about a parcel. The digital information may include information about the particular parcel, the shipper and the receiver's electronic mail address information and/or short message service information such as a mobile telephone number to send a text message, one or more digital photographs of the parcel, and one or more digital photographs of the parcel's location. This embodiment may also include communicating with a wire or wireless network to upload the parcel's digital information to a server. The embodiment may further include storing the parcel's digital information in a database operatively connected to the server and using one or more means, such as a processor, to time stamp the parcel's digital information. Still further, the embodiment may include correlating the parcel's digital information with the digital photograph(s) of the parcel and the photograph of the parcel's location within a predetermined timeframe to prove delivery of the parcel within the predetermined timeframe. Yet further, an embodiment may include using an electronic message address or short messaging service information from the parcel's digital information to generate a delivery notification message to the shipper and/or receiver. Lastly, an embodiment may also include transmitting the delivery notification to the shipper and receiver.

In another embodiment of the present invention, a system for providing proof of the disposition of a parcel that is being transported by a carrier is provided. The system may include an integrated scanner and camera to receive digital information about a parcel. The integrated scanner and camera may read the digital information from a barcode, a QR code, or any other suitable medium to store information that can be optically read by the scanner. The information that may be obtained may include general information about the parcel, the shipper and/or the receiver's electronic mail address information and short message service information, such as a mobile telephone number, and one or more digital photographs of the parcel and one or more digital photographs of the parcel's location. The system may include a communication device, where the communications device enables the integrated scanner and camera to communicate with a server on a wireless or wired network to upload the parcel's digital information to a server. The system may also include a storage device that enables storage of the parcel's digital information in a database that is operatively connected to the server. The system may further include one or more time stamping means, such as a processor, that enable a time stamp to be encoded on the parcel's digital information. One or more processor means may also and correlate the digital photograph of the parcel and the digital photograph of the parcel's location with the general information about the parcel in a predetermined timeframe to prove delivery of the parcel within the predetermined timeframe. Finally, the system may also include a communications module that enables electronic mail messages to be sent to using the electronic message address information or short messaging service information from the parcel's general information to generate and transmit a delivery notification message to the shipper and receiver via a wired or wireless network.

These are but a few embodiments of the invention and other embodiments may pertain to delivery of packages. This summary is not intended to limit the invention as defined by the claims in any way.

### BRIEF DESCRIPTION OF THE DRAWINGS

Having thus described the invention in general terms, reference will now be made to the accompanying drawings, which are not necessarily drawn to scale.

FIG. 1 depicts an illustrative embodiment of a system that may be involved according to principles of the present invention.

FIG. 2 depicts an illustrative embodiment of the steps involved according to the principles of the present invention.

FIG. 3 depicts an illustrative embodiment of a system according to the principles of the present invention.

FIG. 4 depicts an illustrative embodiment of a screen image provided to a user according to the principles of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

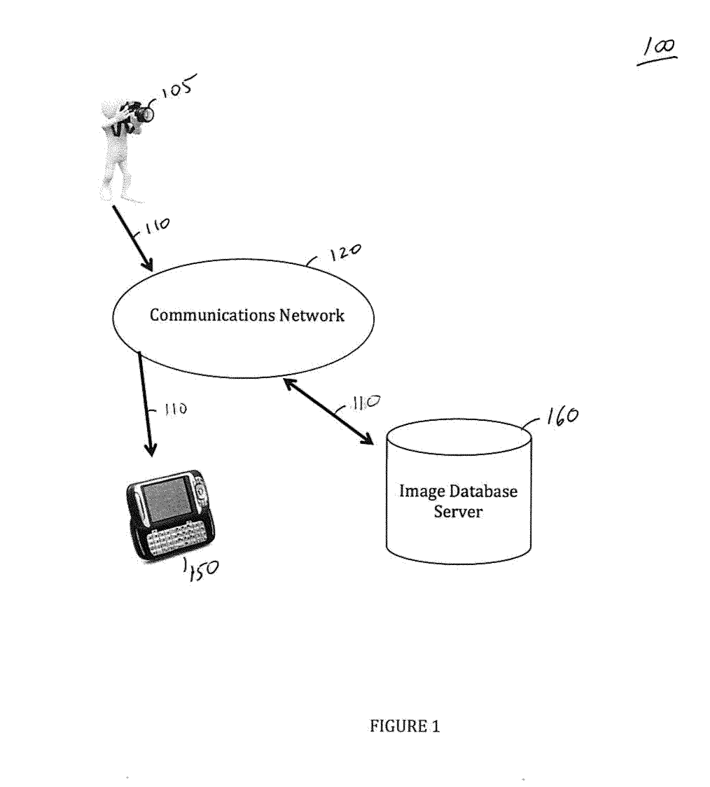

FIG. 1 illustrates an embodiment of system 100 of the present invention. For example, system 100 may include a handheld scanning device 105, communications links 110 that communicate with handheld scanner 105, portable device 150, and image database server 160. Handheld scanning device 105 may include an integrated or separate photographing device such as a camera for photographing one or more digital photographs of a parcel and one or more photographs of the location where the parcel was delivered. For example, the stand alone and/or integrated camera may “snap” a digital photograph of a parcel and the location of where the parcel was delivered.

Handheld scanning device 105 may be used to scan information that may be encoded within one or more bar codes, quick response (“QR”) codes, or any other suitable code that may contain information about the parcel or the parcel's location including but not limited to one or more phone numbers of the sender or the recipient, the parcel's geographic location, one or more Short Message Service (“SMS”) information to enable one or more SMS messages to be sent to a phone number, information relating to sending a plain text message, an electronic mail message, calendar events, size and shape of a parcel, and/or the contents of a parcel.

FIG. 1 also depicts communications network 120 and communication links 110 that may link and provide communication to and from handheld scanner 105, portable device 150, and image database server 160 via communications network 120. System 100 may also include portable device 150 and image database server 160. Portable device 150 may be any device that is capable of receiving and displaying digital textual and graphical electronic information.

Image database server 160 may be server used for storing electronic data. In a desirable embodiment, image database server 160 is configured to connect to communications network 120, such as the Internet. Handheld device 150 may transmit captured data (e.g., photo, video, scanned material) onto the Internet, via addressing and routing schemes, as is known in the art. It is to be understood that the image database server 160 may directly connect to various networks including Wi-Fi networks. Thus, it may not be necessary that the image database server 160 connect to a cell-based network used by cell phones, as network connectivity is already present in the Wi-Fi network due to its inherent TCP/IP Communications network 120 and communication links 110 may be any wired or wireless communications devices and protocols. Communications network 120 and communication links 110 may include any suitable transmission medium, for example, such devices and protocols may be a serial or parallel cable, a wired or wireless dial-up telephone system, a wired or wireless computer network or Internet link, an infrared link, a radio frequency link, a satellite link, any other suitable transmission link or suitable combination of such links. Any suitable transmission or access scheme may be used such as standard serial or parallel communications, Ethernet, Token Ring, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), any other suitable transmission or access scheme, or any suitable combination thereof. Preferably communication links 110 are bidirectional. If desired, however, certain limited communication functions may be accessed using a unidirectional link. An advantage of using a unidirectional scheme for communication links 110 is that such schemes are generally less complicated and then less expensive than bidirectional links.

In practice, system 100 may operate as follows: a user may deliver a package to a specified location. Upon delivery, the user may scan the package using the afore-identified means of obtaining information about the package, its contents, location, and may obtain photographic or video information about the delivered parcel. The image and identification data are sent to an image database server 160 that stores and indexes the image based on the identification data. Typically, a plurality of images of the parcel and photographic evidence of its delivery location are sent to database 160 depicting the parcel and its locations from different perspectives.

Server 160 receiving and storing the digital images typically also stores various related information, such as data files associated with the parcel. Such data files may include one or more phone numbers of the sender and/or the recipient, the parcel's geographic location, one or more Short Message Service (“SMS”) information to enable one or more SMS messages to be sent to a phone number, information relating to sending a plain text message, an electronic mail message, calendar events, size and shape of a parcel, and/or the contents of a parcel. The server may comprise a processor interacting with a database that is local or remote, and the processor may have various interfaces to communicate in order to receive digital images, provide digital images, etc. In other embodiments, the database may be remote to the processor, or closely coupled. Either embodiment is within the scope of the present invention.

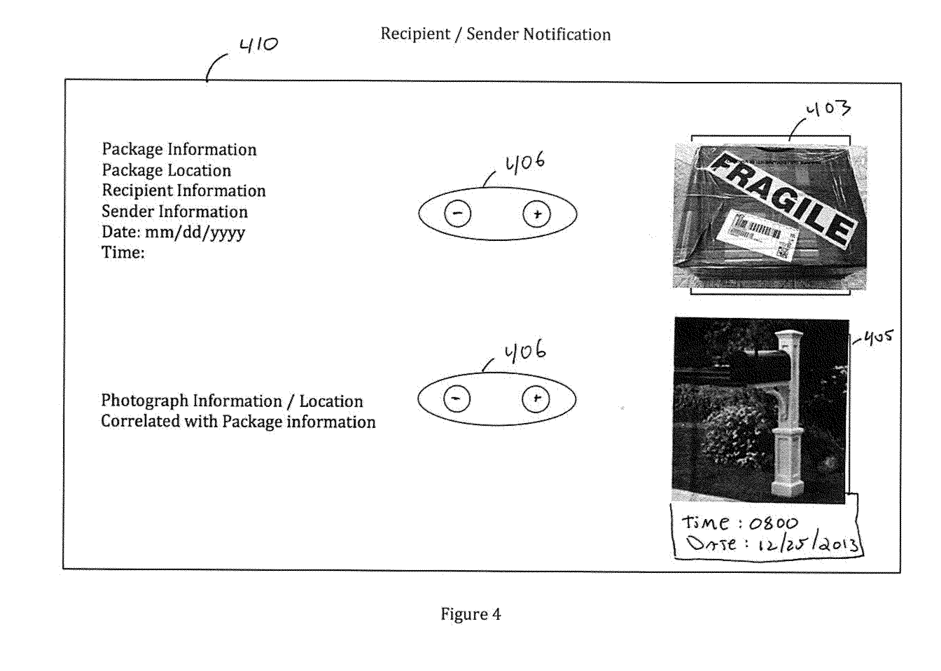

The server may store files, and such files may include one or more phone numbers of the sender and/or the recipient, the parcel's geographic location, one or more Short Message Service (“SMS”) information to enable one or more SMS messages to be sent to a phone number, information relating to sending a plain text message, an electronic mail message, calendar events, size and shape of a parcel, and/or the contents of a parcel. As illustrated in FIG. 4, such information may be graphically received and displayed to a sender or recipient of a parcel and may be correlated with photographic evidence of the parcel's. Correlation may occur when the scanned information is photographed within a predetermined timeframe such as an interval within 30 seconds of the scan and image capture. Those skilled in the art of databases architecture will recognize that a variety of files; data structures; and indexing, linking, and pointing techniques; as well as database software management systems may be used to accomplish the correlation between the textual and image data.

The image database 160 also maintains (or is able to access) contact information for the sender, receiver, and other relevant individuals (not shown). The contact information also indicates (potentially) various communication means that can be used in order of preference to contact the relevant individuals. The contact information is typically in the form of an email address, URL, facsimile number, or telephone number. If an email address is provided, then an automatic email notification message is sent along with the delivery notification and photographic evidence of delivery. Other alternatives include sending messages using short message service (SMS) to a cell phone, instant messaging (IM) over the Internet, facsimile transmission, or other forms of electronic communication may be utilized.

In the embodiment of FIG. 1, the image database 160 sends a delivery notification to portable device 150 via communications links 110 and communications network 120. Typically, the interested party receives a notification notifying them that delivery of the parcel has taken place.

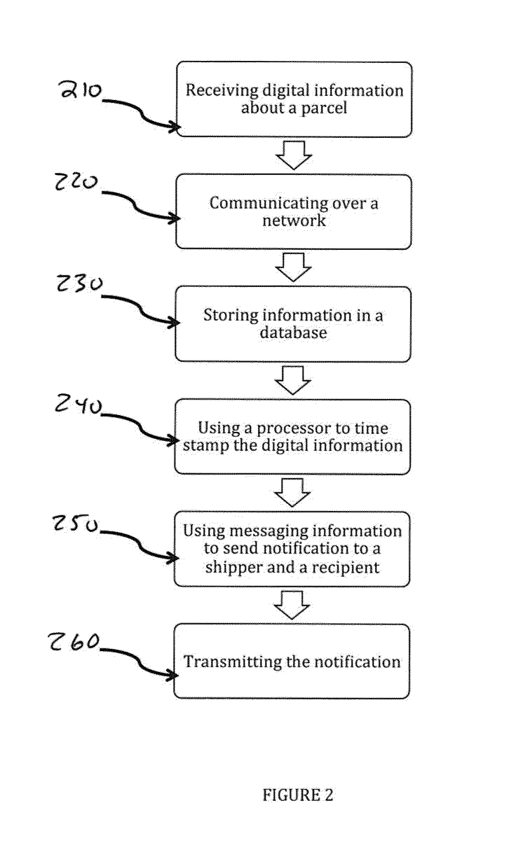

FIG. 2 sets forth the main steps of a method according to an embodiment of the present invention. In step 210, the process begins by receiving digital information about a parcel. Digital information may, for example, include: information about the parcel or the parcel's location including but not limited to one or more phone numbers of the sender or the recipient, the parcel's geographic location, one or more Short Message Service (“SMS”)information to enable one or more SMS messages to be sent to a phone number, information relating to sending a plain text message, an electronic mail message, calendar events, size and shape of a parcel, and/or the contents of a parcel.

In step 220, the method may include communicating over a network. Communicating over a network may include communicating over various networks including Wi-Fi networks. Nevertheless, the step of communicating over a network contemplates using a communications network and communication links that may be any wired or wireless communications devices and protocols. Communicating over a network may include any suitable transmission medium, for example, such devices and protocols may be a serial or parallel cable, a wired or wireless dial-up telephone system, a wired or wireless computer network or Internet link, an infrared link, a radio frequency link, a satellite link, any other suitable transmission link or suitable combination of such links. Any suitable transmission or access scheme may be used such as standard serial or parallel communications, Ethernet, Token Ring, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), any other suitable transmission or access scheme, or any suitable combination thereof. Preferably communication links 110 are bidirectional. If desired, however, certain limited communication functions may be accessed using a unidirectional link. An advantage of using a unidirectional scheme for communication links 110 is that such schemes are generally less complicated and then less expensive than bidirectional links. In step 230, the method may include storing information in a database. The database may a relational database or any other suitable database for organizing data. Optionally, the database may also correlate the digital photographic information with the scanned textual information received from handheld scanner 105. In step 240, the method may further include using a time stamping mean, such as one or more processors to time stamp the digital information received from handheld scanner 105. In step 250, the method may include using messaging information to send a notification to a shipper and a recipient of a parcel. In step 260, the method may include transmitting a notification to the shipper and recipient of a parcel upon successful delivery.

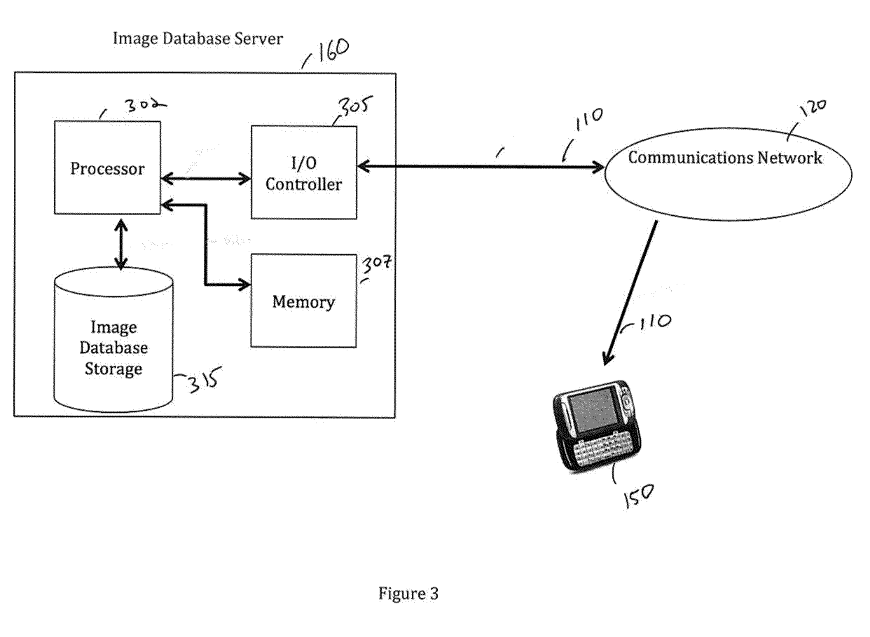

Turning to FIG. 3, image database server 160 comprises a processor 302 accessing image database storage device 315 to store photographic images. The processor further interacts with memory 307 and an I/O controller 305 allowing communication over communications network 120 with the portable device 150. Image database server 160 may be one of a variety of brands or types of computers, from a personal computer to a large multi-processor Internet server. Further, the server may execute one of various types of operating systems and software for performing the indicated functions as is known to those skilled in the art of the Internet. Various architectures and embodiments for the server are possible, and all are intended to be within the scope of the principles of the present invention.

Once the server obtains and stores image data for the parcels (along with other information such as location, time, and tracking number information), the information can be easily searched and retrieved using any of the aforementioned information, particularly the tracking number. Thus, interested parties expecting the delivery of a package at a remote location could be electronically notified of the delivery, and the notification could provide images and data concerning the details of the delivery. For example, server 160 may send digital files to a defined recipient as an email attachment, an SMS message, or any of the aforementioned means of notification. Such proof of delivery can be important in verifying the disposition of an item being delivered. This is particularly useful for the carrier, the shipper, and the recipient.

One embodiment of the user interface is provided in FIG. 4. In FIG. 4, the screen shot 410 typically provides textual information and several images (photos) of the parcel and the location where the parcel was delivered. As shown in FIG. 4, screen 410 may display information about the package, the package location, recipient and sender information, the date and time of delivery. Screen 410 may also show photographic evidence of the location of delivery and such photograph may be time stamped and correlated to the delivery and other parcel information. Typically photo 403 shows an overview of the derived parcel while another photo 405 shows a the location of delivery and may be time stamped to verify that the parcel was delivered to the specific location In some embodiments, the user may activate a control buttons 406 for zooming or panning a particular photo. Other control buttons may provide the user with the ability to view additional photos.

It should be emphasized that the above-described embodiments of the present invention are merely examples of the implementations, and are set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that those skilled in the art will observe that many variations and modifications can be made to the disclosed embodiments without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intend

I claim:

1. A method for providing proof of the disposition of a parcel that is being transported by a carrier, the method comprising:
receiving digital information about a parcel, wherein the digital information includes information comprising, general parcel information, the shipper and the receiver's electronic mail address information and short message service information, and one or more digital photographs of the parcel and one or more digital photographs of the parcel's location;
communicating with a wire or wireless network to upload the parcel's digital information to a server;
storing the parcel's digital information in a database operatively connected to the server;
using one or more time stamping means to time stamp the parcel's digital information;
using one of the electronic message address information and short messaging service information from the parcel's digital information to generate a delivery notification message to the shipper and receiver; and
transmitting the delivery notification to the shipper and receiver of the parcel.

2. The method of claim 1 wherein the general parcel information includes a tracking number, dimensions of the parcel, weight of the parcel, insurance information about the parcel, the sender's address, the receiver's address, and any special delivery instructions.

3. The method of claim 1 wherein the short message service address comprises at least the sender's telephone number and the receiver's telephone number.

4. The method of claim 1 wherein the step of receiving the digital information about the parcel comprises receiving the digital image data with date and time data and global positioning system location data.

5. The method of claim 1 further comprising using a one or more portable computing devices having an integrated digital camera for producing the digital photographs, the portable computing device capable of wirelessly transmitting the digital information about the parcel.

6. A method for providing proof of the disposition of a parcel that is being transported by a carrier, the method comprising:
receiving digital information about a parcel, wherein the digital information includes information comprising, general parcel information, the shipper and the receiver's electronic mail address information and short message service information, and one or more digital photographs of the parcel and one or more digital photographs of the parcel's location;
communicating with a wire or wireless network to upload the parcel's digital information to a server;
storing the parcel's digital information in a database operatively connected to the server;
using one or more processors to time stamp the parcel's digital information;
correlating the parcel's digital information with the digital photograph of the parcel and the photograph of the parcel's location with in a predetermined timeframe to prove delivery of the parcel within the predetermined timeframe;
using one of the electronic message address information and short messaging service information from the parcel's digital information to generate a delivery notification message to the shipper and receiver; and
transmitting the delivery notification to the shipper and receiver of the parcel.

7. The method of claim 6 wherein the general parcel information includes a tracking number, dimensions of the parcel, weight of the parcel, insurance information about the parcel, the sender's address, the receiver's address, and any special delivery instructions.

8. The method of claim 6 wherein the short message services address comprises at least the sender's telephone number and the receiver's telephone number.

9. The method of claim 6 wherein the step of receiving the digital information about the parcel comprises receiving the digital image data with date and time data and global positioning system location data.

10. The method of claim 6 further comprising using a one or more portable computing devices having an integrated digital camera for producing the digital photographs, the portable computing device capable of wirelessly transmitting the digital information about the parcel.

11. A system for providing proof of the disposition of a parcel that is being transported by a carrier, the system comprising:
an integrated scanner and camera to receive digital information about a parcel, wherein the integrated scanner and camera reads digital information that includes information comprising, general parcel information, the shipper and the receiver's electronic mail address information and short message service information, and one or more digital photographs of the parcel and one or more digital photographs of the parcel's location;
a communication device, wherein the communications device enables the integrated scanner and camera to communicate on one of a wireless and wired network to upload the parcel's digital information to a server;
a storage device that enables the digital storage of the parcel's digital information in a database operatively connected to the server;
one or more processors that enables a time stamp to be encoded on the parcel's digital information and wherein the parcel's digital information is correlated with the digital photograph of the parcel and the digital photograph of the parcel's location with in a predetermined timeframe to prove delivery of the parcel within the predetermined timeframe; and
a communications module that enables one of wireless or wired electronic mail messages to be sent to using one of electronic message address information and short messaging service information from the parcel's digital information to generate and transmit a delivery notification message to the shipper and receiver.

12. The system of claim 11 wherein the general parcel information includes a tracking number, dimensions of the parcel, weight of the parcel, insurance information about the parcel, the sender's address, the receiver's address, and any special delivery instructions.

13. The system of claim 11 wherein the short message services address comprises at least the sender's telephone number and the receiver's telephone number.

14. The system of claim 11 wherein the receiver receives digital information including digital image data with date and time data and global positioning system location data.

15. The system of claim 11 further comprising one or more portable computing devices having an integrated digital camera for producing the digital photographs, the portable computing device capable of wirelessly transmitting the digital information about the parcel.
